(19) United States
(12) Patent Application Publication
(10) Pub. No.: US 2013/0160567 A1
(43) Pub. Date: Jun. 27, 2013

(54) FORCE SENSOR

(71) Applicant: CANON KABUSHIKI KAISHA, Tokyo (JP)

(72) Inventors: Tomoichiro Ota, Sagamihara-shi (JP); Masateru Yasuhara, Yokohama-shi (JP)

(73) Assignee: CANON KABUSHIKI KAISHA, Tokyo (JP)

(21) Appl. No.: 13/711,558

(22) Filed: Dec. 11, 2012

(30) Foreign Application Priority Data
Dec. 21, 2011 (JP) 2011-279354
Dec. 21, 2011 (JP) 2011-279355

(51) Int. Cl. G01L 1/18

(52) U.S. Cl. CPC G01L 1/18
USPC 73/862.68

(57) ABSTRACT

A force sensor includes: a planar piezoelectric member whose impedance varies according to an impressing force exerted from an outside; a pair of electrode patterns film-formed on both surfaces of the piezoelectric member; a wiring pattern that is film-formed integrally with the pair of electrode patterns, and connected to the pair of electrode patterns; a power feeding side coil that is provided without contact with the pair of electrode patterns, and connected to an alternating-current source; and a detector that detects variation in impedance of the piezoelectric member, as the impressing force, wherein at least a part or the entirety of one electrode pattern between the pair of electrode patterns is formed volutely extending from the wiring pattern, and is a coil pattern electromagnetically coupled with the power feeding side coil.

### BACKGROUND OF THE INVENTION

1. Field of the Invention

The present invention relates a force sensor that detects an impressing force exerted on a piezoelectric member in a state where alternating voltage is applied to the piezoelectric member.

2. Description of the Related Art

Typically, a force sensor is provided for an end effector of an assembly robot, e.g. a robot hand, such as any of a parallel gripper and a multi-point support device, to detect a gripping force on a workpiece. Distortion gauges and electrostatic sensors have been developed as conventional force sensors. However, since all the force sensors adopting these configurations utilize deformation of elements, a sufficient amount of deformation is required to realize high sensitivity and a wide range of measurement. If the external dimensions are reduced, the sufficient amount of deformation cannot be acquired. Accordingly, the amplitude of an output signal is reduced, a state occurs where the signal amplitude is reduced less than external noise, and the accuracy is low.

Meanwhile, a force sensor adopting a piezoelectric member has been known (see Japanese Patent Publication No. S57-51611). The piezoelectric member causes a voltage according to an instantaneous force, but does not cause a voltage according to a stationary force. Accordingly, an alternating voltage is applied to the piezoelectric member to cause the piezoelectric member to vibrate, and a force is detected according to the amount of variation in voltage amplitude across both the ends of the piezoelectric member at the time based on variation in impedance of the piezoelectric member due to an impressing force exerted from the outside.

A typical power feeding structure to electrodes provided at the piezoelectric member is a structure where wires are connected to the electrodes using any of solder and electrically-conductive adhesive. However, the structure where wires are connected to the electrodes of a force sensor using any of soldering and electrically-conductive adhesive causes a problem in that the vibrating characteristics of the piezoelectric member varies according to the mass of one of the solder and the electrically-conductive adhesive and the mass of the wire to be connected.

Thus, a technique has been considered where wires are made of aluminum foil and pressurized to be in contact with electrodes provided at a piezoelectric member to thereby feed power to the pair of electrodes via the aluminum foil (see Japanese Patent Application Laid-Open No. 2009-198496). This configuration can electrically connect the wires to the electrodes without using solder and electrically-conductive adhesive, and suppress variation in vibrating characteristics of the piezoelectric member. Accordingly, with a good contact condition between the conductive member and the electrode, a stable detection result can be acquired.

Unfortunately, in the structure of feeding power by pressurizing the electrode and the wire against each other to establish contact, the contact resistance between the wire and the electrode sometimes varies according to the state of pressurization to the piezoelectric member. As described above, there is a problem in that variation in contact resistance between the wire and the electrode varies the state of feeding power, which, in turn, varies the detection result.

Thus, it is an object of the present invention to provide a force sensor that can suppress variation in vibrating characteristics of the piezoelectric member, and stably detect the impressing force.

### SUMMARY OF THE INVENTION

The present invention is a force sensor, including: a planar piezoelectric member whose impedance varies according to an impressing force exerted from an outside; a pair of electrode patterns film-formed on both surfaces of the piezoelectric member; a wiring pattern that is film-formed integrally with the pair of electrode patterns, and connected to the pair of electrode patterns; a power feeding side coil that is provided without contact with the pair of electrode patterns, and connected to an alternating-current source; and a detector that detects variation in impedance of the piezoelectric member, as the impressing force, wherein at least a part or the entirety of one electrode pattern between the pair of electrode patterns is formed volutely extending from the wiring pattern, and is a coil pattern electromagnetically coupled with the power feeding side coil.

According to the present invention, the power feeding side coil and the coil pattern film-formed on the piezoelectric member are electromagnetically coupled to each other, which allows electricity to be fed to the pair of electrode patterns film-formed on the piezoelectric member without contacting a wire from the outside to the piezoelectric member. Such contactless feeding allows electricity to be stably fed to the pair of electrode patterns without being affected by the contact state. Since the pair of the electrode patterns and the wiring pattern are integrally film-formed, the patterns has unevenness in mass less than the case of using any of solder and electrically-conductive adhesive. Accordingly, variation in vibrating characteristics of the piezoelectric member can be suppressed, a detection result by the detector can be stabilized, and the impressing force can be accurately detected.

Further features of the present invention will become apparent from the following description of exemplary embodiments with reference to the attached drawings.

### BRIEF DESCRIPTION OF THE DRAWINGS

FIG. 1 is a sectional view illustrating a schematic configuration of a force sensor according to a first embodiment of the present invention.

FIG. 2A is a plan view of a piezoelectric unit.

FIG. 2B is a sectional view of the piezoelectric unit.

FIG. 2C is a bottom view of the piezoelectric unit.

FIG. 3A is a plan view of a base.

FIG. 3B is a sectional view of the base.

FIG. 4A is an electric circuit diagram illustrating a circuit configuration of the force sensor, and is an electric circuit diagram illustrating a circuit configuration where a detector detects a voltage across electrodes of power feeding side coils.

FIG. 4B is an electric circuit diagram illustrating a circuit configuration of the force sensor, and is an electric circuit diagram illustrating circuit configuration where the detector detects a voltage across electrodes of an impedance element.

FIG. 4C is an electric circuit diagram illustrating a circuit configuration of the force sensor, and is an electric circuit diagram illustrating a circuit configuration where the detector detects current flowing through the power feeding side coils.

FIG. 5 is a sectional view illustrating a schematic configuration of a force sensor according to a second embodiment of the present invention.

FIG. 6A is a plan view of the piezoelectric unit.

FIG. 6B is a sectional view of the piezoelectric unit.

FIG. 6C is a bottom view of the piezoelectric unit.

FIG. 7 is a sectional view illustrating a schematic configuration of a force sensor according to a third embodiment of the present invention.

FIG. 8A is a plan view of the piezoelectric unit.

FIG. 8B is a sectional view of the piezoelectric unit.

FIG. 8C is a bottom view of the piezoelectric unit.

FIG. 9 is a sectional view illustrating a schematic configuration of a force sensor according to a fourth embodiment of the present invention.

FIG. 10 is a schematic diagram illustrating a schematic configuration of a robot apparatus embedded with a force sensor according to a fifth embodiment of the present invention.

FIG. 11 is a schematic diagram illustrating a schematic configuration of a robot apparatus including a multi-joint robot arm and a robot hand that are embedded with a force sensor according to a sixth embodiment of the present invention.

FIG. 12 is a sectional view illustrating a schematic configuration of a force sensor according to a seventh embodiment of the present invention.

FIG. 13A is a plan view of a piezoelectric unit.

FIG. 13B is a sectional view of the piezoelectric unit.

FIG. 13C is a bottom view of the piezoelectric unit.

FIG. 14 is an electric circuit diagram illustrating a circuit configuration of the force sensor, and an electric circuit diagram illustrating a circuit configuration where a detector detects a voltage across electrodes of primary coils.

FIG. 15A is an electric circuit diagram illustrating a circuit configuration of the force sensor, and an electric circuit diagram illustrating a circuit configuration where the detector detects a voltage across electrodes of an impedance element.

FIG. 15B is an electric circuit diagram illustrating a circuit configuration of the force sensor, and an electric circuit diagram illustrating a circuit configuration where the detector detects current flowing through the primary coils.

### DESCRIPTION OF THE EMBODIMENTS

Preferred embodiments of the present invention will now be described in detail in accordance with the accompanying drawings.

Embodiments of implementing the present invention will hereinafter be described in detail with reference to drawings.

### First Embodiment

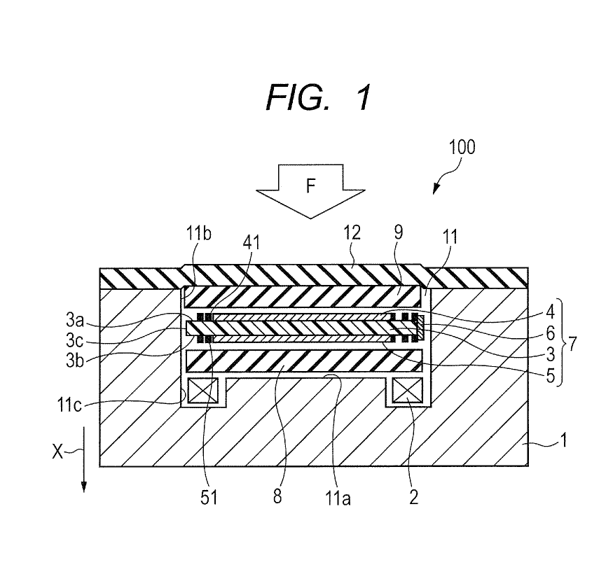

FIG. 1 is a sectional view illustrating a schematic configuration of a force sensor according to a first embodiment of the present invention. As illustrated in FIG. 1, a force sensor 100 includes a base 1 that is a rigid body, a power feeding side coil 2 that is a primary coil fixed to the base 1, a planar piezoelectric member (also called a piezoelectric vibrator) 3 and a pair of electrode patterns 4 and 5 film-formed on both surfaces 3a and 3b of the piezoelectric member 3.

The force sensor 100 further includes a wiring pattern 6 that is formed on a side of the piezoelectric member 3, more specifically, on a part of an outer side surface 3c, film-formed integrally with the pair of electrode patterns 4 and 5, and electrically connected to the pair of electrode patterns 4 and 5. The piezoelectric member 3, the pair of electrode patterns 4 and 5 and the wiring pattern 6 configure a piezoelectric unit 7.

The pair of electrode patterns 4 and 5 and the wiring pattern 6 are film-formed on the piezoelectric member 3, using masking by, for instance, screen printing, physical vapor deposition (PVD) and chemical vapor deposition (CVD). Instead, a conductive film may be formed on the piezoelectric member 3, and subsequently subjected to etching using masking, thereby forming the pair of electrode patterns 4 and 5 and the wiring pattern 6.

The force sensor 100 further includes a support member 8 that intervenes between the base 1 and the piezoelectric member 3 (i.e., the piezoelectric unit 7), supports the piezoelectric member 3 (i.e., the piezoelectric unit 7) with respect to the base 1, and is made of a deformable elastic body (compressive deformation) by an impressing force F exerted on the piezoelectric member 3. The support member 8 is an elastic body made of, for instance, any of rubber and sponge.

The force sensor 100 further includes a force transmission member 9 that is provided facing the plane surface 3a on the reverse side of the plane surface 3b of the piezoelectric member 3 facing the support member 8, and uniformly transmits the impressing force F exerted from the outside to the piezoelectric member 3. In this first embodiment, the force transmission member 9 is made of the elastic body identical to that of the support member 8.

The base 1 is a fixed body that is configured separately from, for instance, a finger body in an end effector of a robot, a robot body of a robot arm or from these bodies, and fixed to the body.

A recess 11 is formed in the base 1. The support member 8, the piezoelectric unit 7 and the force transmission member 9 are sequentially stacked from a bottom 11a to an opening end 11b of the recess 11. The support member 8 is provided on the bottom 11a of the recess 11 so as to intervene between the bottom 11a and the piezoelectric member 3.

For the sake of description, FIG. 1 illustrates the support member 8, the piezoelectric unit 7 and the force transmission member 9 in a manner separated from each other at intervals. In actuality, these adjoining support member 8, piezoelectric unit 7 and force transmission member 9 are in contact with each other.

A covering member 12, which stores and holds the force transmission member 9, the piezoelectric unit 7 and the support member 8 in the recess 11 so as to cover the recess 11, i.e. cover the force transmission member 9, is fixedly provided on the surface of the base 1. This covering member 12 regulates the force transmission member 9, the piezoelectric unit 7 and the support member 8 so as not to drop from the recess 11. The covering member 12 is made of an elastic body, such as any of rubber and sponge, and can transmits the impressing force F to the force transmission member 9.

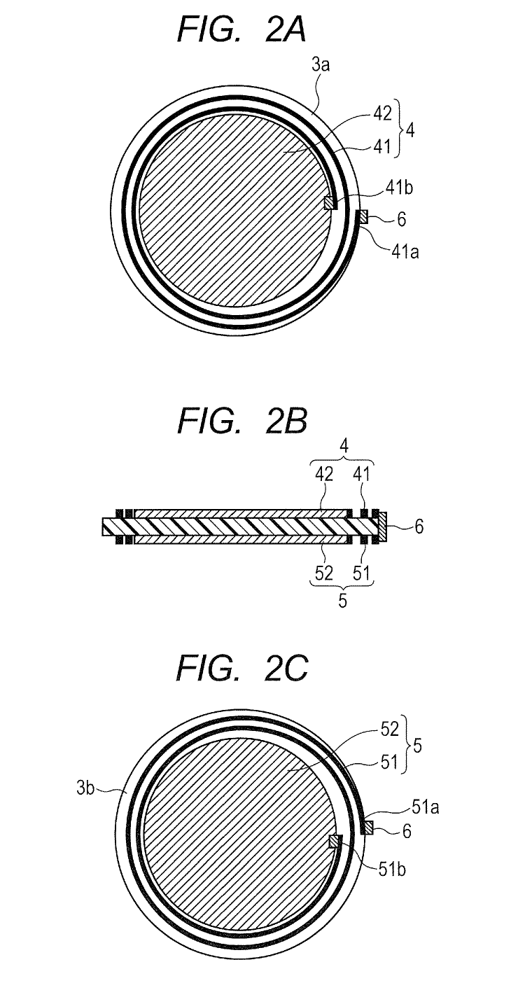

FIGS. 2A to 2C are diagrams illustrating the piezoelectric unit 7. FIG. 2A is a plan view of the piezoelectric unit 7. FIG. 2B is a sectional view of the piezoelectric unit 7. FIG. 2C is a bottom view of the piezoelectric unit 7.

As illustrated in FIGS. 2A and 2B, a part of one electrode pattern (first electrode pattern) 4 between the pair of electrode patterns 4 and 5 is a first coil pattern formed volutely extending from the wiring pattern 6. The remaining part thereof is a first solid pattern 42 connected to the first coil pattern 41. The first coil pattern 41 and the first solid pattern 42 are integrally film-formed on the identical plane surface 3a. This configuration thus negates the need to connect the first coil pattern 41 and the first solid pattern 42 by any of solder and electrically-conductive adhesive.

As illustrated in FIGS. 2B and 2C, a part of the other electrode pattern (second electrode pattern) 5 between the pair of electrode patterns 4 and 5 is a second coil pattern 51 formed volutely extending from the wiring pattern 6. The remaining part thereof is a second solid pattern 52 connected to the second coil pattern 51. The second coil pattern 51 and the second solid pattern 52 are integrally film-formed on the identical plane surface 3b. This configuration thus negates the need to connect the second coil pattern 51 and the second solid pattern 52 by any of solder and electrically-conductive adhesive.

That is, in this first embodiment, the parts of both the electrode patterns of the pair of electrode patterns 4 and 5 are coil patterns.

The first solid pattern 42 and the second solid pattern 52 are correctly opposed to each other sandwiching the piezoelectric member 3. One end 41a of the first coil pattern 41 is connected to the wiring pattern 6. The other end 41b is connected to the first solid pattern 42. One end 51a of the second coil pattern 51 is connected to the wiring pattern 6. The other end 51b is connected to the second solid pattern 52.

The first coil pattern 41 and the second coil pattern 51 are correctly opposed to each other sandwiching the piezoelectric member 3. That is, if one of these coil patterns 41 and 51 is projected onto the other, these patterns overlap with each other in a plan view.

In this first embodiment, the first coil pattern 41 are arranged at the outside of the first solid pattern so as to surround the first solid pattern 42. The second coil pattern 51 is arranged at the outside of the second solid pattern 52 so as to surround the second solid pattern 52. These coil patterns 41 and 51 are connected in series by the wiring pattern 6. These coil patterns 41 and configure a secondary coil to be electromagnetically connected to the power feeding side coil 2.

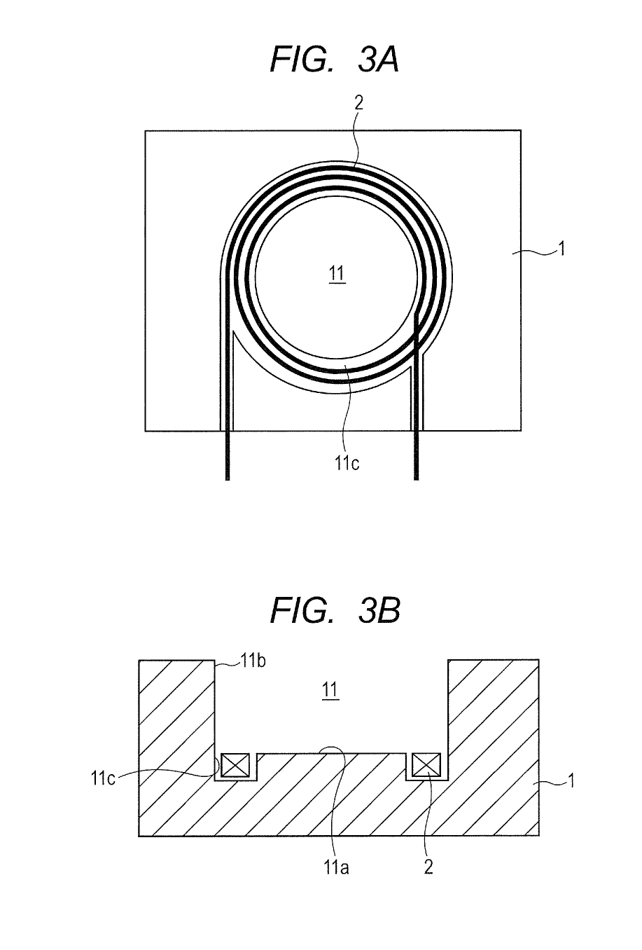

FIGS. 3A and 3B are diagrams illustrating the base 1. FIG. 3A is a plan view of the base 1. FIG. 3B is a sectional view of the base 1. As illustrated in FIGS. 3A and 3B, an annular groove 11c for accommodating the power feeding side coil 2 is formed at the bottom 11a of the recess 11. The power feeding side coil 2 is arranged in the groove 11c. As illustrated in FIG. 1, the power feeding side coil 2 is arranged at a position opposed to the coil patterns 41 and 51 of the electrode patterns 4 and 5 via the support member 8.

Power feeding from the power feeding side coil 2 to the coil patterns 41 and 51 allows alternating voltage to be applied to the pair of electrode patterns 4 and 5, which, in turn, allows an electric field by the pair of electrode patterns 4 and 5 to be applied to the piezoelectric member 3 sandwiched between these patterns. This application causes the piezoelectric member 3 to physically vibrate.

In this first embodiment, the solid patterns 42 and 52 are larger in area than the coil patterns 41 and 51. Accordingly, most of the electric field applied to the piezoelectric member 3 is caused by the solid patterns 42 and 52. However, the electric field is also applied to the coil patterns 41 and 51. That is, the pair of solid patterns 42 and 52 function as electrodes. The pair of coil patterns 41 and 51 function as a secondary coil and also function as electrodes. The pair of electrode patterns 4 and 5 apply the electric field to the piezoelectric member 3, thereby vibrating the piezoelectric member 3.

When the impressing force F is exerted on the piezoelectric member 3 from the outside via the covering member 12 and the force transmission member 9 in this state, the impressing force F is exerted on the support member 8 via the piezoelectric member 3, thereby compressively deforming the support member 8. Accordingly, the impressing force F from the force transmission member 9 is exerted on the one surface 3a of the piezoelectric member 3, and the impressing force F as a reaction from the support member 8 is exerted on the other surface 3b of the piezoelectric member 3. Thus, the impressing force F is uniformly exerted on both the surfaces 3a and 3b of the piezoelectric member 3. This impressing force F changes the vibrating state of the piezoelectric member 3, and changes the impedance of the piezoelectric member 3 according to the impressing force F.

At this time, the piezoelectric member 3 is moved by elastic deformation (compressive deformation) of the support member 8 in a moving direction X perpendicular to the bottom 11a of the recess 11 of the base 1. However, the power feeding side coil 2 is opposed to the coil patterns 41 and 51 via the support member 8. Accordingly, even when the position of the piezoelectric member 3 varies, the correctly opposed state between the power feeding side coil 2 and the coil patterns 41 and 51 is maintained.

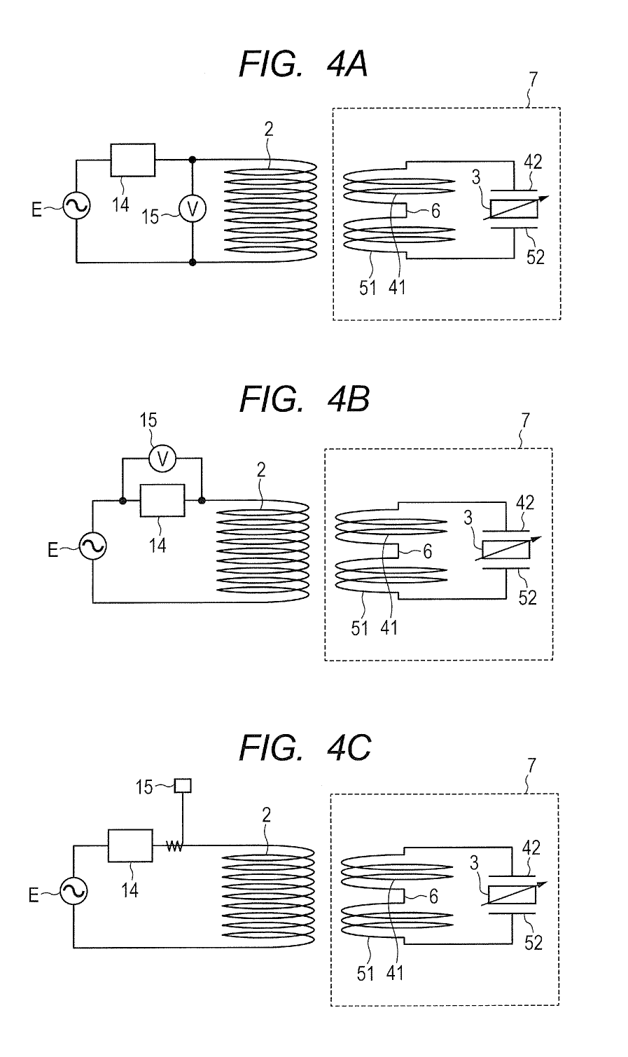

FIGS. 4A to 4C are electric circuit diagrams illustrating circuit configurations of the force sensor. As illustrated in FIG. 4A, the force sensor 100 includes an impedance element 14 connected in series to the power feeding side coil 2, and a detector 15 that detects variation in impedance of the piezoelectric member 3 as the impressing force F exerted on the piezoelectric member 3. The detector 15 is a voltage detector that is connected across the terminals of the power feeding side coil 2, and directly detects a voltage across the terminals of the power feeding side coil 2 varying according to the impedance of the piezoelectric member 3. That is, the detector 15 detects the voltage across the terminals of the power feeding side coil 2 as variation in impedance of the piezoelectric member 3. The impedance element 14 may be any of passive elements, such as a resistance element, a capacitor element and an inductance element. The power feeding side coil 2 is connected to an alternating-current source E via the impedance element 14. The alternating-current source E is a constant-voltage source outputting a constant alternating voltage at a constant frequency. The power feeding side coil 2 is driven by an alternating signal supplied from the alternating-current source E.

The high frequency alternating voltage from the alternating-current source E is applied to the series circuit including the impedance element 14 and the power feeding side coil 2. The alternating voltage applied to the power feeding side coil 2, which is a primary coil, induces an alternating voltage into the coil patterns 41 and 51, which are secondary coils. The coil patterns 41 and 51 and the piezoelectric member 3 sandwiched between the pair of electrode patterns 4 and 5 form an electric resonance circuit. The alternating voltage is applied to the pair of electrode patterns 4 and 5, and an alternating electric field is applied to the piezoelectric member 3. The application vibrates the piezoelectric member 3.

When the impressing force F is exerted on the piezoelectric member 3 to change the vibrating state, the impedance of the piezoelectric member 3 is changed. According to the change, the resonance state of the electric resonance circuit is changed, and the voltage on the sides of the coil patterns 41 and 51, which is the side of the secondary coil, is changed. Accordingly, the voltage across the terminals of the power feeding side coil 2, which is on the primary coil side, is changed. That is, the electromagnetic coupling allows signal communication between the power feeding side coil 2 and the coil patterns 41 and 51. The detector 15 detects the voltage across the terminals of the power feeding side coil 2 varying according to the impedance of the piezoelectric member 3, as the impressing force F.

As illustrated in FIG. 4B, the detector 15, which is a voltage detector, may be connected across the terminals of the impedance element 14, and detect the voltage across the terminals of the impedance element 14 to thereby indirectly detect the voltage across the terminals of the power feeding side coil 2. The alternating voltage output from the alternating-current source E is constant, and divided into the impedance element 14 and the power feeding side coil 2. Accordingly, the voltage across the terminals of the impedance element 14 varies according to variation in voltage across the terminals of the power feeding side coil 2. The voltage (voltage amplitude) detected by the detector 15 at least corresponds to the impedance of the piezoelectric member 3, and the detector detects the impedance of the piezoelectric member 3, i.e., the signal representing the impressing force F exerted on the piezoelectric member 3.

As described above, according to this first embodiment, the electromagnetic coupling between the power feeding side coil 2 and the coil patterns 41 and 51 film-formed on the piezoelectric member 3 enables power to be contactlessly fed to the pair of electrode patterns 4 and 5 film-formed on the piezoelectric member 3 without connecting a wire from the outside to the piezoelectric member 3. Such contactless feeding allows power to be stably fed to the pair of electrode patterns 4 and 5 without being affected by a contact state. The pair of electrode patterns 4 and 5 are formed integrally with the wiring pattern 6 by film-forming. This configuration reduces the variation in mass in comparison with the case of using any of solder and electrically-conductive adhesive. The detector 15 detects the voltage caused in the power feeding side coil 2 as the impressing force F. This configuration negates the need to connect a wire for detection to the pair of electrode patterns 4 and 5. Accordingly, variation in vibrating characteristics of the piezoelectric member 3 can be suppressed, and the detection result by the detector 15 can be stabilized, thereby allowing the impressing force F to be accurately detected.

The power feeding side coil 2 and the coil patterns 41 and 51 are opposed to each other via the support member 8, which is an elastic body. Accordingly, the degree of electromagnetic coupling between the power feeding side coil 2 and the coil patterns 41 and 51 are increased, and the sensitivity of detecting the impressing force F is improved.

The piezoelectric member 3 (i.e., piezoelectric unit 7) is sandwiched between the support member 8 and the force transmission member 9, which are elastic bodies. Thus, the impressing force F is uniformly exerted on both the surfaces 3a and 3b of the piezoelectric member 3. Accordingly, unevenness in vibrating state at each position of the piezoelectric member 3 is reduced. As a result, the detection accuracy of the impressing force F is improved.

The case where the detector 15 detects the voltage of the power feeding side coil 2 has been described. Instead, as illustrated in FIG. 4C, the detector 15 may be a current sensor that detects current flowing through the power feeding side coil 2. The current flowing through the power feeding side coil 2 varies according to the impedance of the piezoelectric member 3 as with the voltage. The detector 15 detects the current flowing through the power feeding side coil 2, thereby detecting the impressing force F exerted on the piezoelectric member 3. That is, the detector 15 may detect at least one of voltage and current of the power feeding side coil 2, which is to be a primary coil, and no wire is required to be connected to the pair of electrode patterns 4 and 5. Accordingly, the detection accuracy is improved.

### Second Embodiment

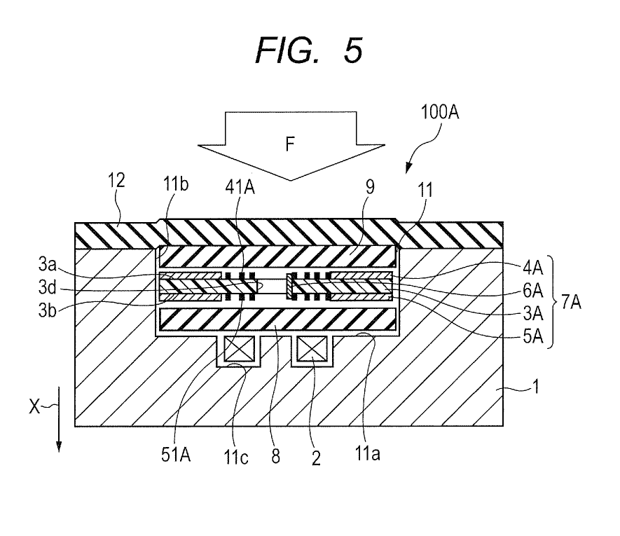

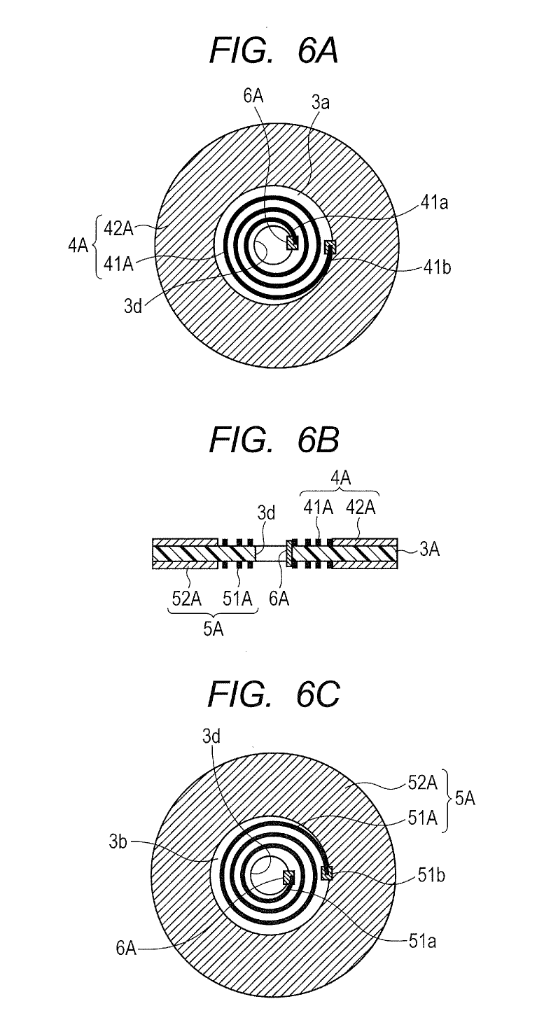

Hereinafter, a force sensor according to a second embodiment of the present invention will be described. FIG. 5 is a sectional view illustrating a schematic configuration of the force sensor according to the second embodiment of the present invention. FIGS. 6A to 6C are diagrams illustrating a piezoelectric unit. FIG. 6A is a plan view of the piezoelectric unit. FIG. 6B is a sectional view of the piezoelectric unit. FIG. 6C is a bottom view of the piezoelectric unit. This second embodiment is different from the first embodiment in the configuration of the piezoelectric unit. The configurational elements other than this unit are analogous to those in the first embodiment. Accordingly, the same symbols are assigned thereto, and the description thereof is omitted.

As illustrated in FIG. 5, a force sensor 100A of this second embodiment includes a piezoelectric unit 7A sandwiched between a support member 8 and a force transmission member 9, which are elastic bodies.

The piezoelectric unit 7A includes a planar piezoelectric member (also called a piezoelectric vibrator) 3A, and a pair of electrode patterns 4A and 5A film-formed on both surfaces 3a and 3b of the piezoelectric member 3A. The piezoelectric member 3A is annularly formed where a through hole is formed at the center.

The piezoelectric unit 7A includes a wiring pattern 6A that is formed on the side surface of the piezoelectric member 3A, more specifically, on a part of an inner surface 3d, film-formed integrally with the pair of electrode patterns 4A and 5A, and electrically connected to the pair of electrode patterns 4A and 5A.

As illustrated in FIGS. 6A and 6B, a part of the one electrode pattern (first electrode pattern) 4A between the pair of electrode patterns 4A and 5A is a first coil pattern 41A formed volutely extending from the wiring pattern 6A. The remaining part thereof is a first solid pattern 42A connected to the first coil pattern 41A. These first coil pattern 41A and first solid pattern 42A are integrally film-formed on the identical plane surface 3a.

As illustrated in FIGS. 6B and 6C, a part of the other electrode pattern (second electrode pattern) 5A between the pair of electrode patterns 4A and 5A is a second coil pattern 51A volutely extending from the wiring pattern 6A. The remaining part thereof is a second solid pattern 52A connected to the second coil pattern 51A. These second coil pattern 51A and second solid pattern 52A are integrally film-formed on the identical plane surface 3b.

That is, in this second embodiment, both the electrode patterns of the pair of electrode patterns 4A and 5A include respective parts that are coil patterns.

The first solid pattern 42A and the second solid pattern 52A are correctly opposed sandwiching the piezoelectric member 3A. One end 41a of the first coil pattern 41A is connected to the wiring pattern 6A. The other end 41b is connected to the first solid pattern 42A. One end 51a of the second coil pattern 51A is connected to the wiring pattern 6A. The other end 51b is connected to the second solid pattern 52A.

In this second embodiment, the first solid pattern 42A and the second solid pattern 52A are annularly formed. The first coil pattern 41A is arranged inside of the first solid pattern 42A. The second coil pattern 51A is arranged inside of the second solid pattern 52A. These coil patterns 41A and 51A are connected in series to each other at the wiring pattern 6A. These coil patterns 41A and 51A configure a secondary coil electromagnetically coupled with the power feeding side coil 2. The first coil pattern 41A and the second coil pattern 51A are correctly opposed to each other sandwiching the piezoelectric member 3A. That is, if one of these coil patterns 41A and 51A is projected onto the other, these patterns overlap with each other in a plan view.

As illustrated in FIG. 5, the power feeding side coil 2, which is the primary coil, is arranged at the position opposed to the coil patterns 41A and 51A via the support member 8. More specifically, the power feeding side coil 2 is arranged in a groove 11c formed in a bottom 11a of a recess 11 so as to be opposed to the coil patterns 41A and 51A. The piezoelectric member 3A is moved by elastic deformation (compressive deformation) of the support member 8 in a moving direction X perpendicular to the bottom 11a of the recess 11 of the base 1. Meanwhile, the power feeding side coil 2 is opposed to the coil patterns 41A and 51A via the support member 8. Accordingly, even when the position of the piezoelectric member 3A varies, the correctly opposed state between the power feeding side coil 2 and the coil patterns 41A and 51A is maintained. The configuration of the detector is analogous to that of the first embodiment.

When a voltage is applied to the pair of electrode patterns 4A and 5A, an electric field is applied to the piezoelectric member 3A. The coil patterns 41A and 51A and the piezoelectric member 3A sandwiched between the electrode patterns 4A and 5A form an electric resonance circuit.

The power feeding side coil 2 is arranged to feed electricity to this resonance circuit. The power feeding side coil 2 is driven by a signal supplied from an alternating-current source analogous to that of the first embodiment. Accordingly, electromagnetic coupling allows signal communication between the power feeding side coil 2 and the coil patterns 41A and 51A on the piezoelectric member 3A.

As illustrated in FIG. 5, the impressing force F exerted on the covering member 12 is uniformly applied to both the surfaces 3a and 3b of the piezoelectric member 3A via the force transmission member 9 and the support member 8. The force F is exerted on both the surfaces 3a and 3b of the piezoelectric member 3A to change the resonance state, and the detector detects at least one of voltage and current at the power feeding side coil 2, which is the primary coil, thereby detecting the applied impressing force F.

As described above, according to this second embodiment, as with the first embodiment, the power feeding side coil 2 and the coil patterns 41A and 51A film-formed on the piezoelectric member 3A are electromagnetic coupled to each other. Accordingly, electricity can be contactlessly fed to the pair of electrode patterns 4A and 5A film-formed on the piezoelectric member 3A without connecting a wire to the piezoelectric member 3A from the outside. Such contactless feeding allows electricity to be stably fed to the pair of electrode patterns 4A and 5A without being affected by the contact state. The pair of electrode patterns 4A and 5A and the wiring pattern 6A are integrally formed by film-forming. Accordingly, unevenness in mass is less than that of the case of using any of solder and electrically-conductive adhesive. As with the first embodiment, the detector detects at least one of voltage and current at the power feeding side coil 2 as the impressing force F. Accordingly, no wire for detection is required to be connected to the pair of electrode patterns 4A and 5A. Accordingly, variation in vibrating characteristics of the piezoelectric member 3A can be suppressed, a detection result by the detector is stabilized, and the impressing force F can be accurately detected.

The power feeding side coil 2 and the coil patterns 41A and 51A are opposed to each other via the support member 8, which is an elastic body. Accordingly, the degree of electromagnetic coupling between the power feeding side coil 2 and the coil patterns 41A and 51A is increased, and the sensitivity of detecting the impressing force F is improved. The piezoelectric member 3A (i.e., piezoelectric unit 7A) is sandwiched between the support member 8 and the force transmission member 9, which are elastic bodies. Thus, the impressing force F is uniformly exerted on both the surfaces 3a and 3b of the piezoelectric member 3A. Accordingly, unevenness in vibrating state at each position of the piezoelectric member 3A is decreased. As a result, the detection accuracy of the impressing force F is improved.

### Third Embodiment

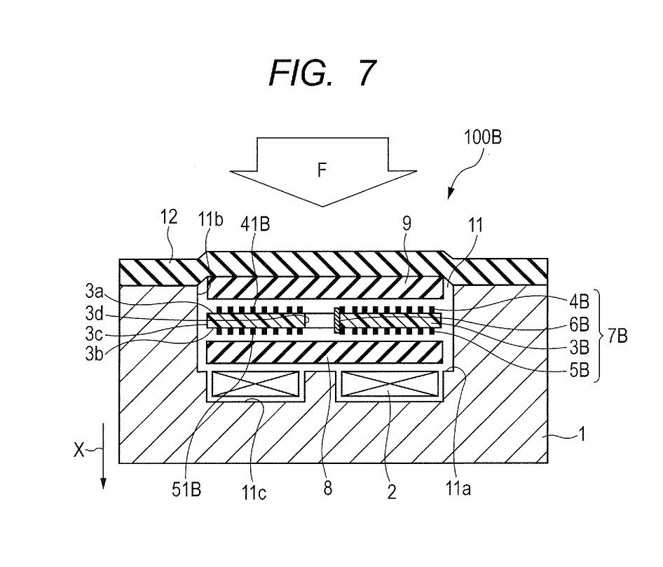

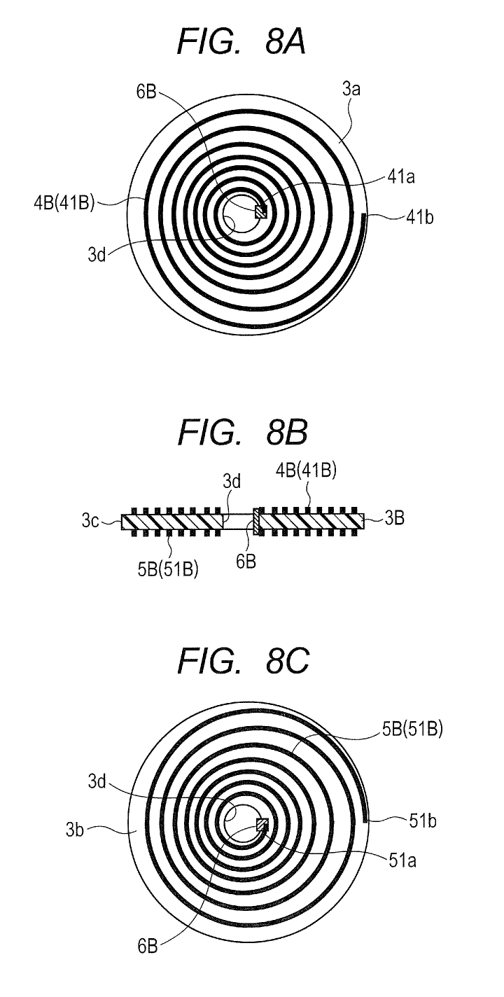

Hereinafter, a force sensor according to a third embodiment of the present invention will be described. FIG. 7 is a sectional view illustrating a schematic configuration of the force sensor according to the third embodiment of the present invention. FIGS. 8A to 8C are a diagrams illustrating a piezoelectric unit. FIG. 8A is a plan view of the piezoelectric unit. FIG. 8B is a sectional view of the piezoelectric unit. FIG. 8C is a bottom view of the piezoelectric unit. This third embodiment is different from the first and second embodiments in the configuration of the piezoelectric unit. The configurational elements other than this unit are analogous to those in the first and second embodiments. Accordingly, the same symbols are assigned thereto, and the description thereof is omitted.

As illustrated in FIG. 7, a force sensor 100B of this third embodiment includes a piezoelectric unit 7B sandwiched between a support member 8 and a force transmission member 9, which are elastic bodies.

The piezoelectric unit 7B includes a planar piezoelectric member (also called a piezoelectric vibrator) 3B, and a pair of electrode patterns 4B and 5B film-formed on both surfaces 3a and 3b of the piezoelectric member 3B. The piezoelectric member 3B is annularly formed where a through hole is formed at the center.

The piezoelectric unit 7B includes a wiring pattern 6B that is formed on the side surface of the piezoelectric member 3B, i.e., on the part of the inner surface 3d in this third embodiment, film-formed integrally with the pair of electrode patterns 4B and 5B, and electrically connected to the pair of electrode patterns 4B and 5B.

As illustrated in FIGS. 8A and 8B, one entire electrode pattern (first electrode pattern) 4B between the pair of electrode patterns 4B and 5B is a first coil pattern 41B formed volutely extending from the wiring pattern 6B.

As illustrated in FIGS. 8B and 8C, the other entire electrode pattern (second electrode pattern) 5B between the pair of electrode patterns 4B and 5B is a second coil pattern 51B formed volutely extending from the wiring pattern 6B.

That is, according to this third embodiment, the entire electrode patterns 4B and 5B are coil patterns.

The first coil pattern 41B and the second coil pattern 51B are correctly opposed to each other sandwiching the piezoelectric member 3B. That is, if one of these coil patterns 41B and 51B is projected onto the other, these patterns overlap with each other in a plan view. One end 41a of the first coil pattern 41B is connected to the wiring pattern 6B. The other end 41b is opened. One end 51a of the second coil pattern 51B is connected to the wiring pattern 6B. The other end 51b is opened.

According to this third embodiment, these electrode patterns 4B and 5B function as secondary coils electromagnetically coupled to the power feeding side coil 2, and function as electrodes applying an electric field to the piezoelectric member 3B.

As illustrated in FIG. 7, the power feeding side coil 2, which is the primary coil, is arranged at a position opposed to the coil patterns 41B and 51B via the support member 8. More specifically, the power feeding side coil 2 is arranged in a groove 11c formed in a bottom 11a of a recess 11 to be opposed to the coil patterns 41B and 51B. The piezoelectric member 3B is moved by elastic deformation (compressive deformation) of the support member 8 in a moving direction X perpendicular to the bottom 11a of the recess 11 of the base 1. Meanwhile, the power feeding side coil 2 is opposed to the coil patterns 41B and 51B via the support member 8. Accordingly, even when the position of the piezoelectric member 3A varies, the correctly opposed state between the power feeding side coil and the coil patterns 41B and 51B is maintained. The configuration of the detector is analogous to that of the first embodiment.

According to the configuration, when voltage is applied to the pair of electrode patterns 4B and 5B, the electric field is applied to the piezoelectric member 3B. The piezoelectric member 3B sandwiched between the coil patterns 41B and 51B and the electrode patterns 4B and 5B form an electric resonance circuit.

The power feeding side coil 2 is arranged to feed electricity to this resonance circuit. The power feeding side coil 2 is driven by a signal supplied from an alternating-current source analogous to that of the first embodiment. Accordingly, electromagnetic coupling allows signal communication between the power feeding side coil 2 and the coil patterns 41B and 51B on the piezoelectric member 3B.

As illustrated in FIG. 7, the impressing force F exerted on the covering member 12 is uniformly applied to both the surfaces 3a and 3b of the piezoelectric member 3B via the force transmission member 9 and the support member 8. The impressing force F is exerted on both the surfaces 3a and 3b of the piezoelectric member 3B to change the resonance state. Accordingly, the detector detects at least one of voltage and current at the power feeding side coil 2, which is the primary coil, thereby detecting the applied impressing force F.

As described above, according to this third embodiment, as with the first embodiment, the power feeding side coil 2 and the coil patterns 41B and 51B film-formed on the piezoelectric member 3B are electromagnetically coupled to each other. Accordingly, without connection of a wire to the piezoelectric member 3B from the outside, electricity can be contactlessly fed to the pair of electrode patterns 4B and 5B film-formed on the piezoelectric member 3B. Such contactless feeding allows electricity to be stably fed to the pair of electrode patterns 4B and 5B without being affected by the contact state. The pair of electrode patterns 4B and 5B and the wiring pattern 6B are integrally formed by film-forming. Accordingly, unevenness in mass is less than that in the case of using any of solder and electrically-conductive adhesive. As with the first embodiment, the detector detects at least one of voltage and current at the power feeding side coil 2 as the impressing force F. Accordingly, no wire for detection is required to be connected to the pair of electrode patterns 4B and 5B. Thus, variation in vibrating characteristics of the piezoelectric member 3B can be suppressed, a detection result by the detector can be stabilized, and the impressing force F can be accurately detected.

The power feeding side coil 2 and the coil patterns 41B and 51B are opposed to each other via the support member 8, which is an elastic body. Accordingly, the degree of electromagnetic coupling between the power feeding side coil 2 and the coil patterns 41B and 51B is increased, and the sensitivity of detecting the impressing force F is improved. The piezoelectric member 3B (i.e., piezoelectric unit 7B) is sandwiched between the support member 8 and the force transmission member 9, which are elastic bodies. Thus, the impressing force F is uniformly exerted on both the surfaces 3a and 3b of the piezoelectric member 3B. Accordingly, unevenness in vibrating state at each position of the piezoelectric member 3B is decreased. As a result, the detection accuracy of the impressing force F is improved.

### Fourth Embodiment

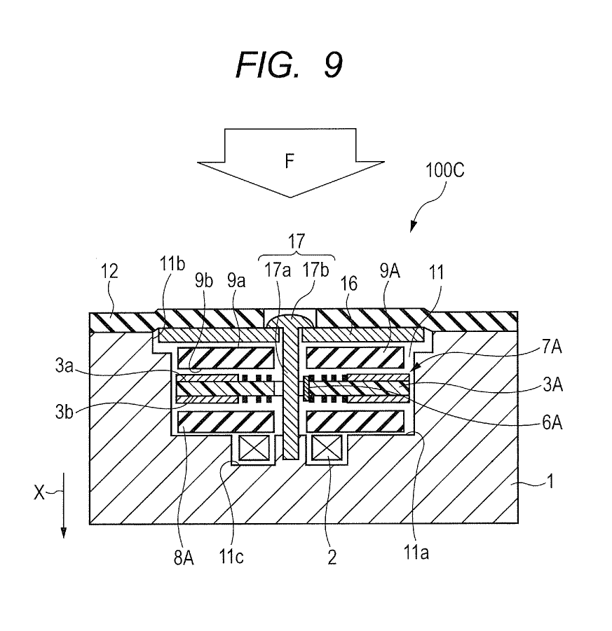

Hereinafter, a force sensor according to a fourth embodiment of the present invention will be described. FIG. 9 is a sectional view illustrating a schematic configuration of the force sensor according to the fourth embodiment of the present invention. This fourth embodiment is different from the second embodiment in the structure of fixing the force transmission member and the piezoelectric unit. The configurational elements other than the structure are analogous to those in the second embodiment. Accordingly, the same symbols are assigned thereto, and the description thereof is omitted.

As illustrated in FIG. 9, a force sensor 100C of this fourth embodiment includes a support member 8A that intervenes between a bottom 11a of a recess 11 of a base 1 and a piezoelectric member 3A, supports the piezoelectric member 3A with respect to the base 1, and is made of elastic body elastically deformed by an impressing force F exerted on the piezoelectric member 3A. The support member 8A is, for instance, an elastic body, such as any of rubber and sponge.

A force sensor 100C further includes a force transmission member 9A that is arranged to face a plane surface 3a on the reverse side of a plane surface 3b of the piezoelectric member 3A facing the support member 8A, and transmits the impressing force F to the piezoelectric member 3. In this fourth embodiment, the force transmission member 9A is formed of the elastic body identical to that of the support member 8A.

The force sensor 100C further includes a plate member 16 that is a rigid member arranged in planar contact with a plane surface 9a on the reverse side of a plane surface 9b of the force transmission member 9A facing the piezoelectric member 3A, and a screw 17 that is a fastener including a shank 17a and a head 17b formed at a proximal end of the shank 17a integrally therewith.

The support member 8A, the piezoelectric member 3A (piezoelectric unit 7A), the force transmission member 9A and the plate member 16 are sequentially stacked in the recess 11 of the base 1, from the bottom 11a toward the opening end 11b. A covering member 12 covering the recess 11, i.e., the plate member 16, is fixedly provided on the surface of the base 1. The covering member 12 is made of an elastic body, such as any of rubber and sponge, and can transmit the impressing force F to the plate member 16.

The plate member 16 transmits the exerted impressing force F to the force transmission member 9A, and is supported by the screw 17 so as to be moved in a moving direction X by the impressing force F based on elastic deformation of the support member 8A. In this fourth embodiment, the moving direction X is perpendicular to the bottom 11a of the recess 1 of the base 1. In this fourth embodiment, the force transmission member 9A is also elastically deformed. Accordingly, compressively deformation of these elements 8A and 9A moves the plate member 16 and the piezoelectric member 3A in the moving direction X.

For the sake of description, FIG. 9 illustrates the support member 8A, the piezoelectric unit 7A, the force transmission member 9A and the plate member 16 in a manner separated at intervals from each other. In actuality, these adjoining support member 8A, piezoelectric unit 7A, force transmission member 9A and plate member 16 are in contact with each other.

The shank 17a of the screw 17 penetrates the support member 8A, the piezoelectric member 3A, the force transmission member 9A and the plate member 16, and is fixed in a manner where the distal end thereof is screwed into a screw hole formed at the bottom 11a of the recess 11 of the base 1. That is, through holes wider than the cross-sectional area of the shank 17a are formed at the support member 8A, the piezoelectric member 3A, the force transmission member 9A and the plate member 16. The shank 17a is freely fitted to these though holes. The through holes are formed at respective center parts of the support member 8A, the piezoelectric member 3A, the force transmission member 9A and the plate member 16. This configuration allows the elements 8A, 3A, 9A and 16 to move in the moving direction X along the shank 17a. A wiring pattern 6A is formed on the through hole of the piezoelectric member 3A.

The head 17b of the screw 17 is in contact with the plate member 16 in a state without load where the impressing force F is not exerted, and supports the plate member 16 so as not to come out. The head 17b is formed wider than the through hole of the plate member 16 to be stopped around the through hole of the plate member 16. Thus, the support member 8A, the piezoelectric member 3A, the force transmission member 9A and the plate member 16 are held in the recess 11 by the screw 17.

As described above, according to this fourth embodiment, the through hole on which the wiring pattern 6A is film-formed is provided at the center part where no vibrating component is caused in the piezoelectric member 3A. Accordingly, the through hole can be used for supporting the piezoelectric member 3A on the base 1 without degrading pressure detection sensitivity.

The simple configuration including the plate member 16 and the screw 17 can easily hold the support member 8A, the piezoelectric member 3A, the force transmission member 9A and the plate member 16 at the base 1 so as not to come out from the base 1.

The present invention is not limited to the aforementioned embodiments. Various variations can be made within a technical thought of the present invention by a person having average knowledge in this field.

In the first embodiment, the case has been described where a part of each of the electrode patterns 4 and 5 is any of the patterns 41 and 51. However, at least a part of one of the electrode patterns may be a coil pattern. That is, one of a part of the electrode pattern 4 and a part of the electrode pattern 5 may be a coil pattern.

In the second embodiment, the case has been described where parts of the respective electrode patterns 4A and 5A may be the coil patterns 41A and 51A. However, at least a part of one of the electrode patterns may be a coil pattern. That is, one of a part of the electrode pattern 4A and a part of the electrode pattern 5A may be a coil pattern.

In the third embodiment, the case has been described where the entirety of both electrode patterns of the pair of electrode patterns 4B and 5B are the coil patterns 41B and 51B. However, the entirety of at least one of the electrode patterns may be a coil pattern. That is, one of the entire electrode pattern 4B and the entire electrode pattern 5A may be a coil pattern.

A part of one electrode pattern between the pair of electrode patterns may be a coil pattern and the entirety of the other electrode pattern may be a coil pattern.

In the third embodiment, the wiring pattern 6B is film-formed on the inner surface 3d. However, the wiring pattern 6B may be film-formed on the outer side surface 3c.

In the first to fourth embodiments, the cases have been described where the force transmission member 9 is an elastic body. However, only if the impressing force F can be uniformly exerted on the surface 3a of the piezoelectric member 3, the member may be a rigid body.

The fixing structure described in the fourth embodiment is applicable to the force sensors in the third embodiment and the other variations.

### Fifth Embodiment

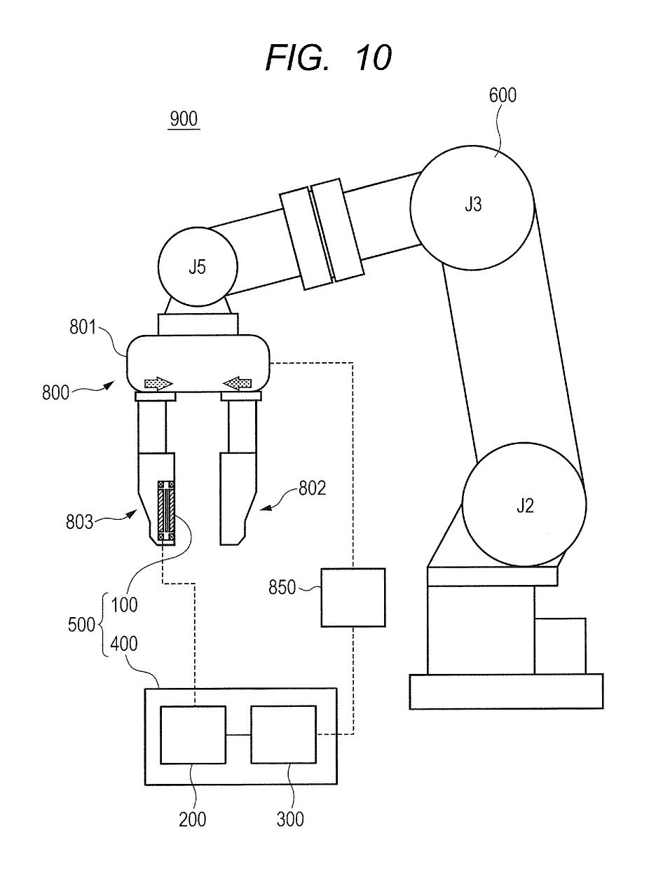

FIG. 10 is a schematic diagram illustrating a schematic configuration illustrating a robot apparatus embedded with a force sensor according to a fifth embodiment of the present invention.

A robot apparatus 900 illustrated in FIG. 10 includes a multi-joint robot arm 600 (six joints J1 to J6 in this embodiment), and a robot hand 800 as an end effector provided at the distal end of the robot arm 600.

The robot apparatus 900 further includes a contact force sensor 500, and a robot hand controller 850 controlling the operations of the robot arm 600 and the robot hand 800.

The contact force sensor 500 includes a sensor body 100, and a detection device 400 connected to the sensor body 100. The sensor body 100 is arranged in a manner embedded on a finger 803 opposed to a finger 802 of the robot hand 800. That is, the sensor body 100 is directly provided on the distal end of a holder of the finger 803 of the robot hand 800. The robot hand 800 detecting pressure is provided at the distal end of the robot arm 600.

### Sixth Embodiment

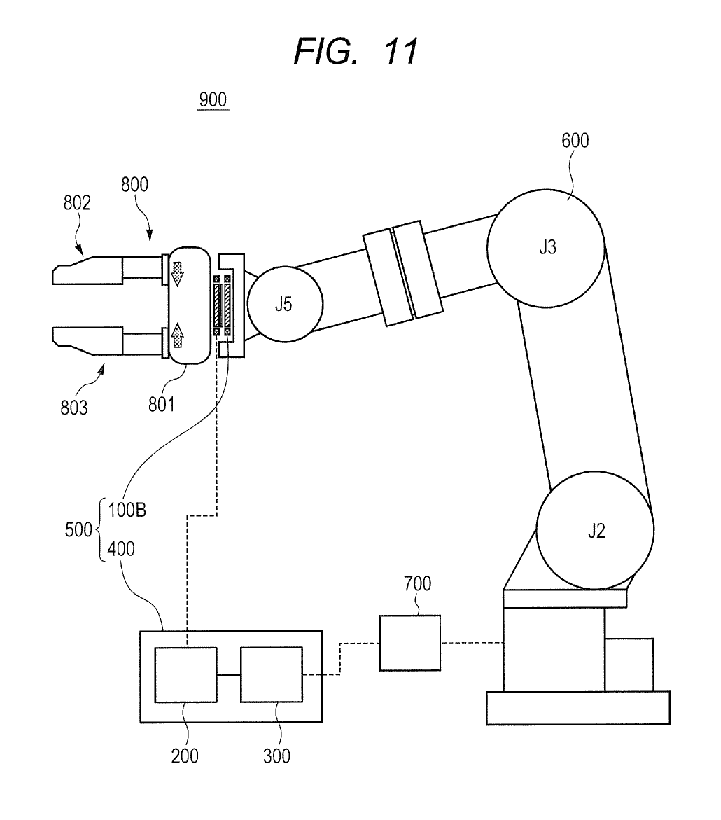

Hereinafter, a multi-joint robot embedded with a force sensor according to a sixth embodiment will be described. FIG. 11 is a schematic diagram illustrating a schematic configuration of a robot apparatus including a multi-joint robot arm and a robot hand embedded with the force sensor the sixth embodiment. The configurational elements analogous to those in the aforementioned embodiment are assigned with the same symbols. The description thereof is omitted.

A robot apparatus 900 illustrated in FIG. 11 includes a multi-joint robot arm 600, and a robot hand 800 that is an end effector provided at the distal end of the robot arm 600.

The robot hand 800 includes a robot hand body 801, and a plurality of fingers 802 and 803 (two fingers in this embodiment) supported by the hand body 801 in a manner capable of being opened and closed.

The robot apparatus 900 includes a contact force sensor 500, and a robot controller 700 controlling an operation of the robot arm 600. The contact force sensor 500 includes a sensor body 100B and a detection device 400 connected to the sensor body 100B.

The multi-joint robot arm 600 includes the sensor body 100B of the force sensor on a surface coupled with the robot hand 800.

The multi-joint robot arm may include any of force sensors of the embodiments. In this embodiment, the arm includes the force sensor analogous to the third embodiment. The sensor body 100B of the force sensor is arranged intervening at a part for connection with the robot hand 800. The sensor body 100B may be provided at the robot hand 800.

The force of an object detected by the force sensor 100B is applied to the piezoelectric unit 7B via the support member 8 and the force transmission member 9, by a force applied to the robot hand 800. According to the structure of the force sensor 100B as illustrated in FIG. 7, the impressing force is exerted on both the surfaces 3a and 3b of the piezoelectric member 3B to change the resonance state. Accordingly, the detection device 400 detects the change of a signal component of the power feeding side coil 2, thereby detecting the value of the applied force.

The robot controller 700, which controls the robot arm 600, computes a control signal corresponding to the applied force based on the value of the applied and detected force, and drives the joints J1 to J6 of the multi-joint robot 600, thereby controlling the force to the object.

### Seventh Embodiment

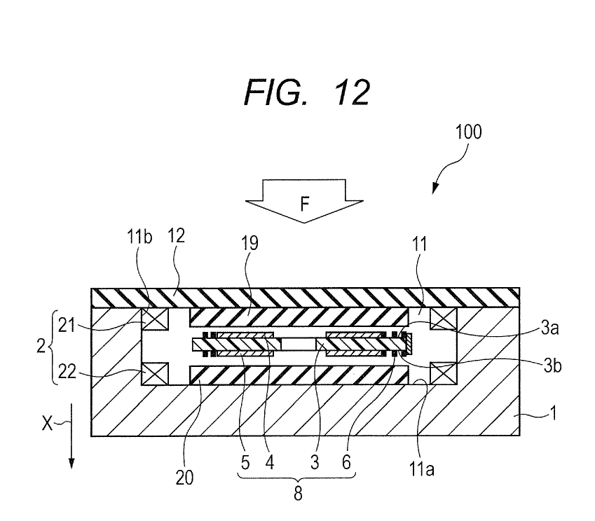

FIG. 12 is a sectional view illustrating a schematic configuration of a force sensor according to a seventh embodiment of the present invention.

Elements identical to those in the embodiments may be assigned with the identical symbols.

As illustrated in FIG. 12, the force sensor 100 includes a base 1 that is a rigid body, a primary coil 2 fixed to the base 1, a planar piezoelectric member (also called a piezoelectric vibrator) 3, and a pair of electrodes 4 and 5 provided on respective surfaces 3a and 3b of the piezoelectric member 3.

The force sensor 100 further includes a secondary coil 6 that is connected to the pair of electrodes 4 and 5, arranged without contact to the primary coil 2, and electromagnetically coupled to the primary coil 2. The one electrode (first electrode) 4 between the pair of electrodes 4 and 5 is fixedly provided on the one plane surface 3a of the piezoelectric member 3. The other electrode (second electrode) 5 is fixedly provided on the other plane surface 3b of the piezoelectric member 3.

In this embodiment, the secondary coil 6 is fixedly provided across both the surfaces 3a and 3b of the piezoelectric member 3. The piezoelectric member 3, the pair of electrodes 4 and 5, and the secondary coil 6 configure a piezoelectric unit 8. The force sensor 100 further includes a support member 20 that intervenes between the base 1 and the piezoelectric member 3 (i.e., the piezoelectric unit 8), supports the piezoelectric member 3 (i.e., the piezoelectric unit 8) with respect to the base 1, and is elastically deformed (compressively deformed) by an impressing force F received by the piezoelectric member 3. The support member 20 is an elastic body, for instance, any of rubber and sponge.

The force sensor 100 further includes a force transmission member 19 that is provided facing the plane surface 3a on the reverse side of the plane surface 3b facing the support member 20 of the piezoelectric member 3, and uniformly transmits the impressing force F applied from the outside to the piezoelectric member 3. In this embodiment, the force transmission member 19 is made of the same elastic body as that of the support member 20.

The base 1 is a fixed body that is configured separately from, for instance, a finger body in an end effector of a robot, a robot body of a robot arm and from these bodies, and fixed to the body. A recess 11 is formed in the base 1. The support member 20, the piezoelectric unit 8 and the force transmission member 19 are stacked in the recess 11 sequentially from the bottom 11a of the recess 11 toward the opening end 11b. The support member is arranged on the bottom 11a of the recess 11 in a manner of intervening between the bottom 11a and the piezoelectric member 3.

For the sake of description, FIG. 12 illustrates the support member 20, the piezoelectric unit 8 and the force transmission member 19 in a manner separated from each other at intervals. In actuality, these adjoining support member 20, piezoelectric unit 8 and force transmission member 19 are in contact with each other. A covering member 12, which stores and holds the force transmission member 19, the piezoelectric unit 8 and the support member 20 in the recess 11 so as to cover the recess 11, i.e., cover the force transmission member 19, is fixedly provided on the surface of the base 1. This covering member 12 regulates the force transmission member 19, the piezoelectric unit 8 and the support member 20 so as not to come out the recess 11. The covering member 12 is made of an elastic body, such as any of rubber and sponge, and can transmit the impressing force F to the force transmission member 19.

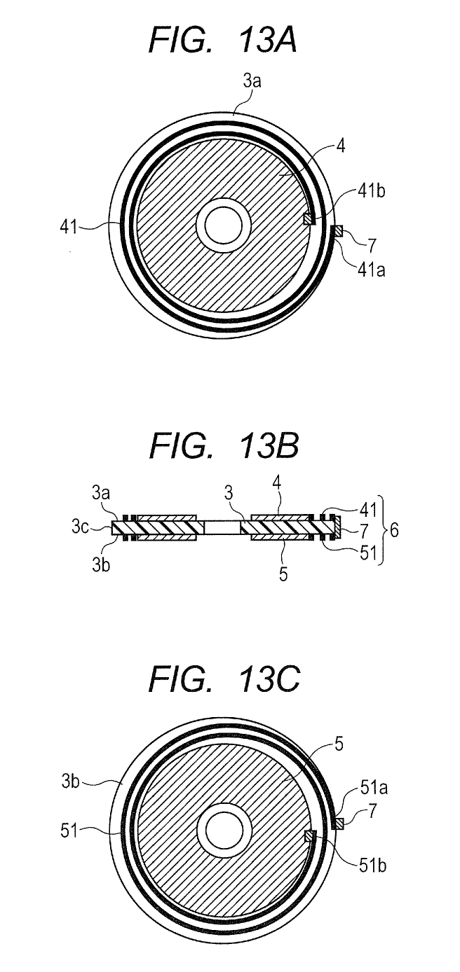

FIGS. 13A to 13C are diagrams illustrating the piezoelectric unit 8. FIG. 13A is a plan view of the piezoelectric unit 8. FIG. 13B is a sectional view of the piezoelectric unit 8. FIG. 13C is a bottom view of the piezoelectric unit 8. In this embodiment, the secondary coil 6 includes a first coil pattern 41 formed on the one plane surface 3a of the piezoelectric member 3, and a second coil pattern 51 formed on the other plane surface 3b of the piezoelectric member 3, and is configured by connecting the coil patterns 41 and 51 by a wiring pattern 7.

The first coil pattern 41 and the second coil pattern 42 are formed volutely on the respective plane surfaces 3a and 3b. The wiring pattern 7 is formed on the side of the piezoelectric member 3, more specifically, on a part of the outer side surface 3c. The first electrode 4 is formed on the one plane surface 3a of the piezoelectric member 3. The second electrode 5 is formed on the other plane surface 3b of the piezoelectric member 3. The electrodes 4 and 5, the coil patterns 41 and 51 and the wiring pattern 7 are film-formed integrally with the piezoelectric member 3, using masking by, for instance, screen printing, physical vapor deposition (PVD) and chemical vapor deposition (CVD). Instead, a conductive film may be formed on the piezoelectric member 3, and subsequently etching may be performed using masking, thereby forming the electrodes 4 and 5, the coil patterns 41 and 51 and the wiring pattern 7.

As illustrated in FIGS. 13A and 13B, the first electrode 4 and the first coil pattern 41 are integrally film-formed on the identical plane surface 3a. This configuration negates the need to connect the first electrode 4 and the first coil pattern 41 by any of solder and electrically-conductive adhesive.

As illustrated in FIGS. 13B and 13C, the second electrode 5 and the second coil pattern 51 are integrally film-formed on the identical plane surface 3b. This configuration negates the need to connect the second electrode 5 and the second coil pattern 51 by any of solder and electrically-conductive adhesive. The first electrode 4 and the second electrode 5 are correctly opposed to each other sandwiching the piezoelectric member 3. The one end 41a of the first coil pattern 41 is connected to the wiring pattern 7. The other end 41b is connected to the first electrode 4. The one end 51a of the second coil pattern 51 is connected to the wiring pattern 7. The other end 51b is connected to the second electrode 5. The first coil pattern 41 and the second coil pattern 51 are correctly opposed to each other sandwiching the piezoelectric member 3. That is, if one of these coil patterns 41 and 51 is projected onto the other, these patterns overlap with each other in a plan view.

This embodiment adopts the configuration where the secondary coil 6 connects the first coil pattern 41 and the second coil pattern 51 in series. However, the configuration is not limited thereto. The secondary coil 6 may be a coil pattern provided on a plane surface of any of the surfaces 3a and 3b of the piezoelectric member 3.

The case has been described where the secondary coil 6 is integrally film-formed on the pair of electrodes 4 and 5. However, the configuration is not limited thereto only if this coil is fixed to the piezoelectric member 3 so as to move integrally with the piezoelectric member 3. In this case, the secondary coil 6 is only required to be electrically connected to the pair of electrodes 4 and 5.

Electricity is contactlessly fed from the primary coil 2 to the secondary coil 6 illustrated in FIG. 12. Accordingly, an alternating voltage is applied to the pair of electrodes 4 and 5, and an electric field by the pair of electrodes 4 and 5 is applied to the piezoelectric member 3 sandwiched therebetween, which physically vibrates the piezoelectric member 3. In this state, when the impressing force F is applied to the piezoelectric member 3 from the outside via the covering member 12 and the force transmission member 19, the impressing force F is exerted on the support member 20 via the piezoelectric member 3 to thereby compressively deform the support member 20. This deformation exerts the impressing force F from the force transmission member 19 on the one surface 3a of the piezoelectric member 3, and exerts the impressing force F that is a reaction from the support member 20 on the other surface 3b of the piezoelectric member 3. Thus, the impressing force F is uniformly exerted on both the surfaces 3a and 3b of the piezoelectric member 3. The impressing force F changes the vibrating state of the piezoelectric member 3. The impedance of the piezoelectric member 3 changes according to the impressing force F.

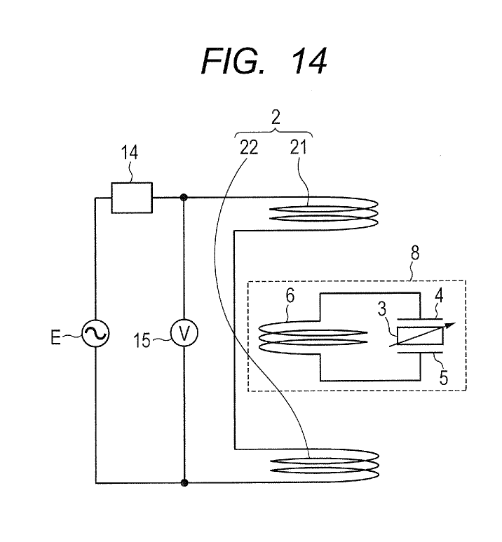

FIG. 14 is an electric circuit diagram illustrating a circuit configuration of the force sensor.

As illustrated in FIG. 14, the force sensor 100 includes the impedance element 14 connected in series to the primary coil 2, and the detector 15 that detects variation in impedance of the piezoelectric member 3 as the impressing force F exerted on the piezoelectric member 3. The detector 15 is a voltage detector that is connected across the terminals of the primary coil 2, and directly detects the voltage across the terminals of the primary coil 2 varying according to the impedance of the piezoelectric member 3. That is, the detector 15 directly detects the voltage across the terminals of the primary coil 2 as variation in impedance of the piezoelectric member 3.

The impedance element 14 is a passive element, such as any of a resistance element, a capacitor element and an inductance element. The primary coil 2 is connected to the alternating-current source E via the impedance element 14. The alternating-current source E is a constant-voltage source outputting a constant alternating voltage at a constant frequency.

The primary coil 2 is driven by an alternating signal supplied from the alternating-current source E. A high frequency alternating voltage from the alternating-current source E is applied to the series circuit including the impedance element 14 and the primary coil 2. The alternating voltage applied to the primary coil 2 induces an alternating voltage in the secondary coil 6. The secondary coil 6 and the piezoelectric member 3 sandwiched between the pair of electrodes 4 and 5 form an electric resonance circuit. The alternating voltage is applied to the pair of electrodes 4 and 5. The alternating electric field is applied to the piezoelectric member 3. The application vibrates the piezoelectric member 3. When application of the impressing force F to the piezoelectric member 3 changes the vibrating state, the impedance of the piezoelectric member 3 is changed. According to the change, the resonance state of the electric resonance circuit changes, thereby changing the voltage on the side of the secondary coil 6. The change, in turn, changes the voltage across the terminals of the primary coil 2. That is, electromagnetic coupling allows signal communication between the primary coil 2 and the secondary coil 6.

The detector 15 detects the voltage across the terminals of the primary coil 2 varying according to the impedance of the piezoelectric member 3, as the impressing force F. That is, the voltage (voltage amplitude) of the primary coil 2 detected by the detector 15 corresponds the impedance of the piezoelectric member 3. The detector 15 detects the impedance of the piezoelectric member 3, i.e., a signal representing the impressing force F exerted on the piezoelectric member 3.

As illustrated in FIGS. 12 and 14, in this embodiment, the primary coil 2, which is one coil between the primary coil and the secondary coil, is divided into a first coil piece 21 and a second coil piece 22 connected in series to each other. As illustrated in FIG. 12, the first coil piece 21 and the second coil piece 22 are arranged separately from each other at an interval in a moving direction X of the piezoelectric member 3 based on elastic deformation (compressive deformation) of the support member 20.

In this embodiment, the moving direction X is perpendicular to the bottom 11a of the recess 11 of the base 1. The secondary coil 6, which is the other coil between the primary coil 2 and the secondary coil 6 is arranged between the first coil piece 21 and the second coil piece 22 with respect to the moving direction X. That is, the piezoelectric member 3 to which the secondary coil 6 is fixed is arranged between the first coil piece 21 and the second coil piece 22 with respect to the moving direction X. The first coil piece 21 of the primary coil 2 is arranged on the side of the opening end 11b of the recess 11. The second coil piece 22 is arranged on the side of the bottom 11a of the recess 11.

In this embodiment, the coil pieces 21 and 22 are directly fixed to the base 1. Instead, these pieces may be fixed to the base 1 via a fastener. Hereinafter, referring to FIG. 12, an operation will be described where an external force is applied to the piezoelectric unit 8 including the secondary coil 6 and the piezoelectric member 3 sandwiched between the pair of electrodes 4 and 5 to move this unit in the vertical direction in FIG. 12 with respect to the base 1. The case where the piezoelectric unit 8 is moved downward with respect to the base 1 will be described. In the case where the piezoelectric unit 8 is moved downward, the distance between the first coil piece 21 of the primary coil 2 and the secondary coil 6 is increased. Accordingly, the degree of coupling between the coils 21 and 6 is decreased. According to a signal supplied from the alternating-current source E, which is a signal source, via the first coil piece 21 of the primary coil 2, the power induced into the secondary coil 6 is reduced. At the same time, the distance between the second coil piece 22 of the primary coil 2 and the secondary coil 6 is reduced. This reduction increases the degree of coupling between the coils 22 and 7, and the power induced into the secondary coil 6 is increased according to the signal supplied from the alternating-current source E, which is the signal source, via the second coil piece 22 of the primary coil 2. Owing to the operation, the power supplied by the signal from the alternating-current source E as the signal source to the pair of electrodes 4 and 5 is maintained substantially constant in spite of adverse effects due to movement of the piezoelectric member 3.

Hereinafter, an operation where the piezoelectric unit 8 is moved upward with respect to the base 1 will be described.

When the piezoelectric unit 8 is moved upward, the distance between the first coil piece 21 of the primary coil 2 and the secondary coil 6 is reduced. This reduction increases the degree of coupling between the coils 21 and 6, and increases the power induced into the secondary coil 6 according to the signal supplied from the alternating-current source E as the signal source via the first coil piece 21 of the primary coil 2. At the same time, the distance between the second coil piece 22 of the primary coil 2 and the secondary coil 6 is increased. This reduces the degree of coupling between the coils 22 and 6, and reduces the power induced into the secondary coil 6 according to the signal supplied from the alternating-current source E as the signal source via the second coil piece 22 of the primary coil 2. According to such an operation, the power supplied to the pair of electrodes 4 and 5 according to the signal from the alternating-current source E as the signal source is maintained substantially constant in spite of adverse effects due to movement of the piezoelectric member 3.

As described above, this embodiment allows the power to be contactlessly fed to the pair of electrodes 4 and 5 by the electromagnetic coupling between the primary coil 2 and the secondary coil 6. Because there is no need to connect a feeding wire to the pair of the electrodes 4 and 5 from the outside, adverse effects due to the connecting state and contact state of the feeding wire are not exerted, and variation in a detection result of the impressing force can be suppressed. Furthermore, even when the position of the piezoelectric member 3 varies and the positional relationship between the primary coil 2 and the secondary coil 6 varies, the detection result of the impressing force by the detector 15 can be suppressed.

This suppression negates the need to separately provide a compensating circuit for feedback control, allows the detection result by the detector 15 to be stabilized with the simple configuration, can suppress the cost from increasing, omit the compensating circuit, and realize reduction in size of the force sensor 100.

The first electrode 4 and the first coil pattern 41 are integrally film-formed on the one plane surface 3a of the piezoelectric member 3. The second electrode 5 and the second coil pattern 51 are integrally film-formed on the other plane surface 3b of the piezoelectric member 3. Accordingly, unevenness in mass is less than that in the case of using any of solder and electrically-conductive adhesive.

The detector 15 detects voltage caused in the primary coil 2, as the impressing force F. Thus, no wire is required to be connected to the pair of electrodes 4 and 5. Accordingly, variation in vibrating characteristics of the piezoelectric member 3 can be suppressed, the detection result by the detector 15 can be stabilized, and the impressing force F can be accurately detected.

The piezoelectric member 3 (i.e., piezoelectric unit 8) is sandwiched between the support member 20 and the force transmission member 19, which are elastic bodies. Thus, the impressing force F is uniformly exerted on both the surfaces 3a and 3b of the piezoelectric member 3. Accordingly, unevenness of the vibrating state at each position of the piezoelectric member 3 is reduced. As a result, the detection accuracy in impressing force F is improved.

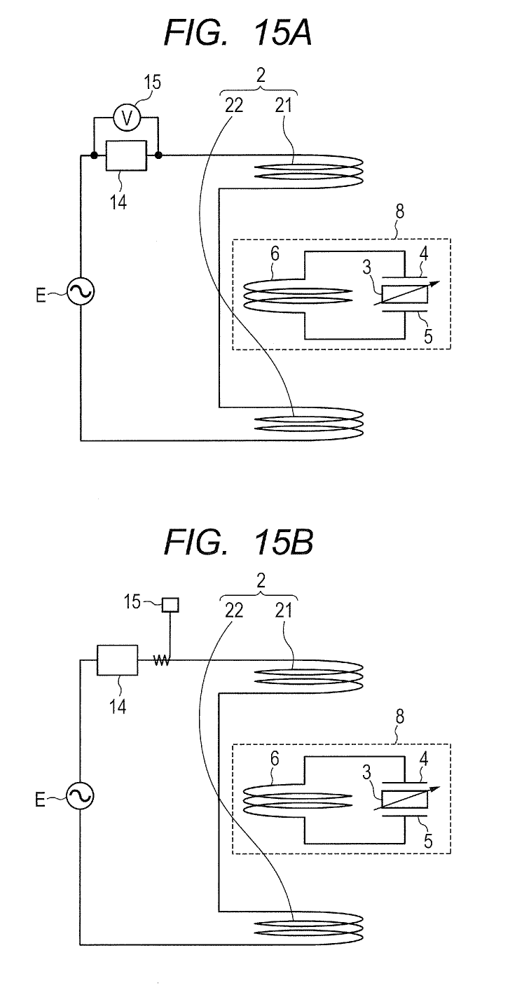

As illustrated in FIG. 15A, the detector 15, which is the voltage detector, may be connected across the terminals of the impedance element 14, and detect the voltage across the terminals of the impedance element 14 to thereby indirectly detect the voltage across the terminals of the primary coil 2. The alternating voltage output from the alternating-current source E is constant, and divided to the impedance element 14 and the primary coil 2. Accordingly, the voltage across the terminals of the impedance element 14 varies according to the voltage across the terminals of the primary coil 2. The voltage (voltage amplitude) detected by the detector 15 at least corresponds to the impedance of the piezoelectric member 3, and the detector 15 detects the impedance of the piezoelectric member 3, i.e., the signal representing the impressing force F exerted on the piezoelectric member 3.

As illustrated in FIG. 15B, the detector 15 may be a current sensor detecting current flowing through the primary coil 2. As with the voltage, the current flowing through the primary coil 2 varies according to the impedance of the piezoelectric member 3. Accordingly, the detector 15 detects current flowing through the primary coil 2 to thereby detect the impressing force F exerted on the piezoelectric member 3. That is, the detector 15 may detect at least one of voltage and current of the primary coil 2. There is no need to connect a wire to the pair of electrodes 4 and 5. Accordingly, the detection accuracy is improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2011-279354, filed Dec. 21, 2011, and No. 2011-279355, filed Dec. 21, 2011 which are hereby incorporated by reference herein in their entirety.

What is claimed is:

1. A force sensor, comprising:
a planar piezoelectric member whose impedance varies according to an impressing force exerted from an outside;
a pair of electrode patterns film-formed on both surfaces of the piezoelectric member;
a wiring pattern that is film-formed integrally with the pair of electrode patterns, and connected to the pair of electrode patterns;
a power feeding side coil that is provided without contact with the pair of electrode patterns, and connected to an alternating-current source; and
a detector that detects variation in impedance of the piezoelectric member, as the impressing force,
wherein at least a part or the entirety of one electrode pattern between the pair of electrode patterns is formed volutely extending from the wiring pattern, and is a coil pattern electromagnetically coupled with the power feeding side coil.

2. The force sensor according to claim 1,
wherein the detector detects at least one of voltage and current of the power feeding side coil varying according to the impedance of the piezoelectric member, as the impressing force.

3. The force sensor according to claim 1, further comprising:
a base to which the power feeding side coil is fixed;
a support member that intervenes between the base and the piezoelectric member, supports the piezoelectric member with respect to the base, and is formed of an elastic body elastically deformed by the impressing force received by the piezoelectric member; and
a force transmission member that is arranged facing a surface on the reverse side of a surface facing the support member for the piezoelectric member, and transmits the impressing force to the piezoelectric member.

4. The force sensor according to claim 3,
wherein the power feeding side coil is arranged at a position opposed to the coil pattern via the support member.

5. The force sensor according to claim 3, further comprising:
a plate member that is in planar contact with a surface on the reverse side of a surface of the force transmission member that faces the piezoelectric member, transmits the impressing force to the force transmission member, and is moved in a moving direction based on elastic deformation of the support member by the impressing force; and
a fastener includes a shank that penetrates the support member, the piezoelectric member, the force transmission member and the plate member and whose distal end is fixed to the base, and a head that is integrally formed at a proximal end of the shank and supports the plate member so as not to come out.

6. A robot apparatus, comprising:
a robot arm; and
the force sensor according to claim 1 included in the robot arm.

7. A force sensor, comprising:
a primary coil connected to an alternating-current source;
a base to which the primary coil is fixed;
a planar piezoelectric member whose impedance varies according to an impressing force exerted from an outside;
a support member that intervenes between the base and the piezoelectric member, supports the piezoelectric member of the base, and is formed of an elastic body elastically deformed by the impressing force exerted on the piezoelectric member;
a pair of electrodes provided on both surfaces of the piezoelectric member;
a secondary coil that is connected to the pair of electrodes, and electromagnetically coupled with the primary coil; and
a detector that detects variation in impedance of the piezoelectric member, as the impressing force,
wherein one coil between the primary coil and the secondary coil is divided into a first coil piece and a second coil piece connected in series to each other,
the first coil piece and the second coil piece are arranged in a moving direction of the piezoelectric member based on elastic deformation of the support member in a manner separated from each other at an interval, and
the other coil between the primary coil and the secondary coil is arranged between the first coil piece and the second coil piece with respect to the moving direction.

8. A robot apparatus, comprising:
a robot arm; and
the force sensor according to claim 7 included in the robot arm.
